(19) United States
(12) Patent Application Publication
(10) Pub. No.: US 2012/0189208 A1
(43) Pub. Date: Jul. 26, 2012

(54) IMAGE PROCESSING APPARATUS, IMAGE PROCESSING METHOD, IMAGE PROCESSING PROGRAM, AND STORAGE MEDIUM

(75) Inventors: Motoyuki Inaba, Fujimion (JP); Tatsuya Orimo, Itabashi (JP); Hisashi Owada, Shinagawa (JP)

(73) Assignee: PIONEER CORPORATION, Kanagawa (JP)

(21) Appl. No.: 13/395,797

(22) PCT Filed: Sep. 16, 2009
(86) PCT No.: PCT/JP2009/066154

§ 371 Date: Mar. 13, 2012

(51) Int. Cl. G06K 9/46

(52) U.S. Cl. 382/195

(57) ABSTRACT

An image processing apparatus (100, 200, 300) is provided with: an obtaining device (110, 130, etc.) for obtaining a first image; an extracting device (110) for extracting a texture image from the obtained first image; a first enlarging device (120) for enlarging the extracted texture image; a second enlarging device (130) for enlarging the obtained first image; a base image obtaining device (140) for obtaining a base image in which a sharpening process is performed on a contour of the enlarged first image to sharpen the contour; and a combining device (150) for combining the enlarged texture image and the obtained base image.

### TECHNICAL FIELD

The present invention relates to an image processing apparatus using, for example, a bilateral filter, an image processing method, an image processing program, and a storage medium.

### BACKGROUND ART

As this type of image processing apparatus, an apparatus for performing a sharpening process after an enlargement process is general. As a general sharpening process, a technology described in a patent document 1 is disclosed. The patent document 1 and the like disclose a technology of making steep rising and falling of the contoured portion of an image without adding any overshoot and undershoot by using a scaling circuit.

Moreover, a non-patent documents 1 and the like disclose a technology about the bilateral filter as a non-linear filter capable of removing a noise component without blurring the contour of the image.

Moreover, a non-patent document 2 and the like disclose a technology about the bilateral filter for making a steep inclination in a spatial direction of a pixel value in the contoured portion of the image.

Moreover, a non-patent document 3 and the like disclose a technology about an image enlargement process based on the separation of a skeleton component and a texture component. This technology separates an input image into the skeleton component and the texture component and adopts interpolation suitable for each component, thereby keeping the contour sharp without generating jaggies and ringing while keeping a fine texture component.

### PRIOR ART DOCUMENT

### Patent Document

Patent document 1: Japanese Patent Application Laid Open No. 2002-16820

### Non-Patent Document

Non-Patent document 1: Kiichi URAHAMA, “Noise Reduction and Generation of Illustrations by Using Bilateral Filters”, The Journal of the Institute of Image Information and Television Engineers, Vol. 62, No. 8, pp. 1268-1273 (2008)
Non-Patent document 2: Kiichi URAHAMA, Kohei INOUE, “Edge-Enhancement Property of Bilateral Filters”, The Transactions of the Institute of Electronics, Information and Communication Engineers A, 2003/3 Vol. J86-A, No. 3
Non-Patent document 3: Takahiro SAITO, Yuki ISHII, Yousuke NAKAGAWA, Takashi KOMATSU, “Application of Multiplicative Skeleton/Texture Image Decomposition to Image Processing”, The Transactions of the Institute of Electronics, Information and Communication Engineers D, Vol. J90-D, No. 7, pp. 1682-1685
Non-Patent document 4: Kaoru ARAKAWA, “Nonlinear Digital Filters and Their Applications”, The Journal of the Institute of Electronics, Information and Communication Engineers, Vol. 77, No. 8, pp. 844-852, August 1994

### DISCLOSURE OF INVENTION

### Subject to be Solved by the Invention

However, according to the conventional technologies by the patent document 1 and the like described above, the image enlargement process causes the noise component, such as rough step-like edges which appear in a diagonal line portion and a curved line portion out of the contour of the image, i.e. so-called jaggies, and a false contour which is generated near the contour of the image, i.e. so-called ringing. Moreover, the sharpening process enhances or hardly reduces the noise component such as the jaggies and the ringing, which is technically problematic. In particular, the noise component such as the jaggies and the ringing tends to be generated in pixels having a large difference in the pixel value between adjacent pixels, such as around the contour of the image, i.e. around an edge.

In view of the aforementioned problems, it is therefore an object of the present invention to provide an image processing apparatus, an image processing method, an image processing program, and a storage medium capable of effectively suppressing the generation of the noise component and improving image quality more properly.

### Means for Solving the Subject

The above object of the present invention can be achieved by an image processing apparatus provided with: an obtaining device for obtaining a first image; an extracting device for extracting a texture image from the obtained first image; a first enlarging device for enlarging the extracted texture image; a second enlarging device for enlarging the obtained first image; a base image obtaining device for obtaining a base image in which a sharpening process is performed on a contour of the enlarged first image to sharpen the contour; and a combining device for combining the enlarged texture image and the obtained base image.

According to the image processing apparatus of the present invention, by the obtaining device which is provided, for example, with a memory, a processor, and the like, the first image is obtained. By the extracting device which is provided, for example, with a memory, a processor, and the like, the texture image is extracted from the obtained first image. Here, the “first image” of the present invention means an image such as a frame image, a color image, and a black and white image, which is imaged by, for example, a camera, a video camera, or the like and which constitutes, for example, a picture and a motion picture. The “texture image” of the present invention means an image including a component in which the pixel value of each pixel changes minutely in comparison with its surrounding pixels. Typically, the “texture image” means an image composed of pixels with a small change in the pixel value. The “base image” of the present invention means an image in which a texture component is almost or completely removed from the image. Typically, the “base image” is composed of a contour portion in which the pixel value changes significantly and a flat portion in which the pixel value changes uniformly. Moreover, the “pixel value” of the present invention means an index indicating the degree of a property level, such as luminance, chromaticity, or saturation, by a pixel unit. Moreover, the term “extract” in the present invention typically means to directly or indirectly “extract”, “identify”, “sort”, “distinguish”, “recognize”, “select”, “screen”, or perform similar actions on only the texture image in the image.

By the first enlarging device which is provided, for example, with a memory, a processor, and the like, the extracted texture image is enlarged. By the second enlarging device which is provided, for example, with a memory, a processor, and the like, the obtained first image is enlarged.

In particular, by the base image obtaining device which is provided, for example, with a memory, a processor, and the like, the base image in which the sharpening process is performed on the contour of the enlarged first image to sharpen the contour is obtained. The “sharpening process” of the present invention means image processing for making the steep inclination of a change in a spatial direction of the pixel value of the contour of the image. Then, by the combining device, the enlarged texture image and the obtained base image are combined.

As described above, in the present invention, the sharpening process is performed on the first image which is subject to the enlargement process, by using a bilateral filter or a trilateral filter. Incidentally, regarding the bilateral filter having an effect of sharpening the contour, i.e. a so-called edge, please refer to the non-patent document 2. Moreover, the bilateral filter or the trilateral filter also have a noise removal effect. Regarding the bilateral filter having the noise removal effect, please refer to the non-patent document 1. Since a noise mainly includes a small change in the image, it is similar to the texture component. Thus, in the image which is subject to the sharpening process, the texture component is also removed. Thus, the base image obtained after the sharpening process is a visually uncomfortable image in which the granularity and details of the image are reduced, and it is not preferable in practice. Thus, in the present invention, by subtracting the first image which is subject to the filtering process by using the bilateral filter and an ε filter from the first image, the texture image is extracted. The extracted texture image is subject to the enlargement process and then is combined with the base image, thereby obtaining an output image. By this, the contour, i.e. the edge, is sharpened and the image without losing its granularity and details can be obtained, which is extremely preferable in practice.

As described above, in the present invention, by that the second enlarging device enlarges the input image, the image processing can be performed on an image which is neither a deteriorated image nor an image lacking image information. Thus, it is possible to obtain a visual effect for further sharpening the contoured portion, which is extremely preferable in practice.

If an image obtained by performing a separation process on the input image is inputted to the second enlarging device, the image information for expressing the contour is deteriorated or reduced by the separation process, and it is hard to sharpen the contour of the image on a sharpening part after the second enlarging device, which is technically problematic.

In one aspect of the image processing apparatus of the present invention, the base image obtaining device obtains the base image by using a bilateral filter or a trilateral filter.

Moreover, in another aspect of the image processing apparatus of the present invention, the extracting device extracts the texture image by subtracting, from the obtained first image, an image obtained by performing bilateral filtering or εfiltering on the obtained first image.

In general, the image enlargement process increases the degree of the generation of the noise component such as jaggies and ringing. In particular, the noise component such as jaggies and ringing tends to be generated at a position having a large difference in the pixel value between adjacent pixels, such as around the contour of the image, i.e. around the edge. Thus, if the sharpening process is performed after the enlargement process is performed on the obtained first image, the noise component such as jaggies and ringing generated in the enlargement process is further enhanced in the enlarged image obtained by enlarging the first image, and as a result of the image processing, the degree of the generation of the noise component is increased in the outputted image, which is technically problematic.

In contrast, according to this aspect, the bilateral filter or the trilateral filter of the base image obtaining device can smooth and reduce the noise component such as jaggies and ringing generated in the enlarged first image by the action of noise removal that the bilateral filter and the like have. Moreover, since the texture image is obtained by subtracting, from the first image, the image obtained by performing the bilateral filtering or the ε filtering on the first image, a difference in the pixel value between pixels which constitute the texture image is extremely small. This makes it possible to remarkably suppress the generation of the noise component such as jaggies and ringing if the enlargement process is performed on the texture image by the first enlarging device.

As a result, it is possible to obtain the image in which the generation of the noise component such as jaggies and ringing, which is likely generated in the enlargement process, is effectively suppressed.

In another aspect of the image processing apparatus of the present invention, it is further provided with a correcting device for performing at least one of a first correction process and a second correction process, the first correction process performing on the enlarged texture image a correction according to a property of the enlarged texture image, the second correction process performing on the obtained base image a correction according to a property of the obtained base image, the combining device combining the texture image and the base image after the at least one of the correction processes is performed.

According to this aspect, the texture image is distinguished from the base image, and each of the texture image and the base image can be corrected in an appropriate method according to the characteristics of each of the texture image and the base image. Consequently, as a result of the image processing, the image quality of the outputted image can be further increased.

In another aspect of the image processing apparatus of the present invention, the correcting deice performs at least one correction of a 3-dimensional noise reduction process, an isolated point removal process, a non-linear process, and a multiplication process on the enlarged texture image as the first correction process, thereby correcting the enlarged texture image.

According to this aspect, the correcting device performs, as the first correction process, the 3-dimensional noise reduction process which is a filtering process in a time-axis direction, i.e. a so-called 3DNR process, only on the texture image not including the contour of the image, i.e. an edge portion. By this, the 3DNR process does not influence the contour of the image at all. This makes it possible to effectively reduce the generation of an afterimage while removing a random noise by the 3DNR, which is extremely useful in practice.

If the 3DNR process is performed on the base image without distinguishing between and correcting the texture image and the base image, there is such a technical problem that the degree of the generation of the after image becomes high. In particular, the afterimage is generally detected in the contour of the image, i.e. in the edge portion. Thus, the afterimage is generated in the base image and eventually in the output image outputted after the combination of the base image and the texture image, and the image quality is reduced, which is technically problematic.

Alternatively, the correcting device performs the isolated point removal process only on the texture image as the first correction process. By this, the isolated point removal process is performed with little or no influence of an image portion in which the pixel value significantly changes, such as the contour of the image, i.e. the edge portion. Thus, it is possible to increase the accuracy of detecting the noise, such as an isolated point, and to effectively perform the noise removal, which is extremely useful in practice.

Alternatively, the correcting device performs the non-linear process and the multiplier process on the texture image but not on the base image. This makes it possible to maintain the pixel value in the edge portion and the flat portion in the base image. Thus, it is possible to improve the granularity and details of the image without generating over-exposure or under-exposure, which is caused by the pixel value goes up and down in the entire image, and it is also possible to increase the contrast of the image, which is extremely preferable in practice.

In another aspect of the image processing apparatus of the present invention, the correcting deice performs at least one process of a gradation correction process and a transient correction process on the obtained base image as the second correction process, thereby correcting the obtained base image.

According to this aspect, as the second correction process, the gradation correction process is performed on the base image in which the texture component is reduced. Thus, the gradation correction process can be well performed. Specifically, the pixel value can be linearly changed depending on a gradual change in the pixel value in the base image in which the texture component is reduced, and the gradation correction process can be well performed.

If the gradation correction process is performed on the image having a high proportion of the texture component, there is a possibility that the texture component is an obstacle and that the gradation correction process cannot be properly performed, which is technically problematic.

Alternatively, as the second correction process, the transient correction process is performed on the base image in which the texture component is reduced. Thus, the transient correction process can be well performed. Specifically, in the base image in which the texture component is reduced, the inclination of the contour can be made steep depending on a gradual change in the pixel value near the contour without influencing the texture component, and thus, the transient correction process can be well performed.

If the transient correction process is performed on the image having a high proportion of the texture component, there is a possibility that the texture component is an obstacle and that the transient correction process cannot be properly performed, which is technically problematic.

In another aspect of the image processing apparatus of the present invention, it is further provided with a measuring device for measuring a distribution of frequency components in an arbitrary area of the obtained one first image or each first image of a group of a plurality of first images, wherein in addition to or instead of that the base image obtaining device obtains the base image on the basis of the measured distribution of frequency components, the extracting device extracts the texture image on the basis of the measured distribution of frequency components.

According to this aspect, it is possible to maintain the degree of the granularity and details of the image at a certain level on the basis of the measured distribution of frequency components, which is extremely preferable in practice.

In another aspect of the image processing apparatus of the present invention, in addition to or instead of that the base image obtaining device obtains the base image by changing at least one of the number of taps and a filter coefficient in accordance with the measured distribution of frequency components, the extracting device extracts the texture image by changing at least one of the number of taps and the filter coefficient in accordance with the measured distribution of frequency components.

Here, the number of taps means a value for expressing the range of pixels, which is an image processing target, by a pixel unit. Moreover, the filter coefficient means a parameter for controlling a filter property. Typically, in the case of the ε filter, the filter coefficient means an ε value or the selection of a non-linear function. In the case of the bilateral filter or the trilateral filter, the filter coefficient means a α value and a β value.

According to this aspect, typically, if the frequency of a high-frequency component included in the measured distribution of frequency components or time integration of the frequency exceeds a predetermined value, the number of taps may be changed in an increase direction, and if the frequency of the high-frequency component or the time integration of the frequency does not exceed the predetermined value, the number of taps may be changed in a reduction direction.

As a result, it is possible to maintain the degree of the granularity and details of the image at a certain level by changing the number of taps on the basis of the measured distribution of frequency components with respect to the inputted various first images, which is extremely preferable in practice.

In another aspect of the image processing apparatus of the present invention, the measuring device initializes the measurement of the frequency components in each scene or each channel in obtaining the first image.

According to this aspect, it is possible to maintain the degree of the granularity and details of the image at a certain level with respect to the inputted various first images.

In another aspect of the image processing apparatus of the present invention, the base image obtaining device obtains the base image on the basis of enlargement information for enlarging the first image in addition to the measured distribution.

According to this aspect, it is possible to maintain the degree of the granularity and details of the image at a certain level and at higher accuracy with respect to the inputted various first images. Typically, the product of the number of taps based on the measured distribution of frequency components and a magnification included in the enlargement information may be set as the number of taps.

The above object of the present invention can be also achieved by an image processing method provided with: an obtaining process of obtaining a first image; an extracting process of extracting a texture image from the obtained first image; a first enlarging process of enlarging the extracted texture image; a second enlarging process of enlarging the obtained first image; a base image obtaining process of obtaining a base image in which a sharpening process is performed on a contour of the enlarged first image to sharpen the contour; and a combining process of combining the enlarged texture image and the obtained base image.

According to the image processing method of the present invention, it is possible to receive the same various benefits as those of the image processing apparatus of the present invention. Incidentally, in response to various aspects of the image processing apparatus of the present invention, the image processing method of the present invention can also adopt various aspects.

The image processing program of the present invention is an image processing program executed by an apparatus comprising a computer, the image processing program making the computer function as: an obtaining device for obtaining a first image; an extracting device for extracting a texture image from the obtained first image; a first enlarging device for enlarging the extracted texture image; a second enlarging device for enlarging the obtained first image; a base image obtaining device for obtaining a base image in which a sharpening process is performed on a contour of the enlarged first image to sharpen the contour; and a combining device for combining the enlarged texture image and the obtained base image.

According to the image processing program of the present invention, the image processing apparatus of the present invention described above can be relatively easily realized as the computer reads and executes the computer program from a recording medium for storing the computer program, such as a ROM, a CD-ROM, a DVD-ROM, and a hard disk, or as it executes the computer program after downloading the program through a communication device.

Incidentally, in response to various aspects of the image processing apparatus of the present invention, the image processing product of the present invention can also adopt various aspects.

The storage medium of the present invention stores therein the image processing program described above (including its various aspects).

According to the storage medium of the present invention, by making the computer read the image processing program described above, it is possible to make the computer appropriately function as the image processing apparatus of the present invention described above.

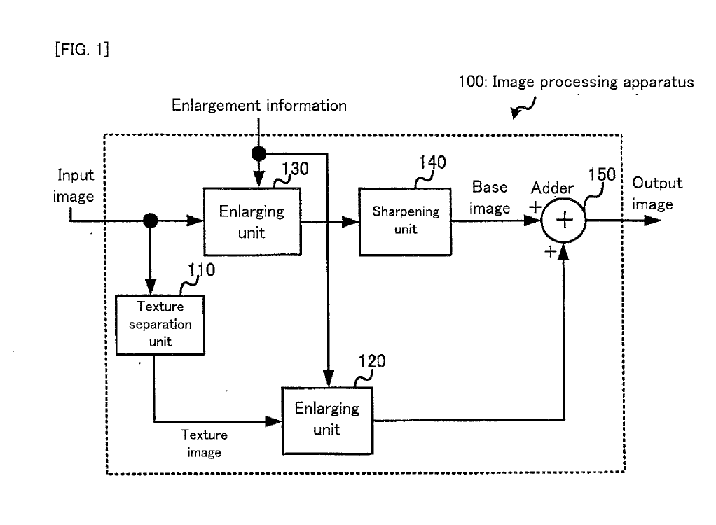

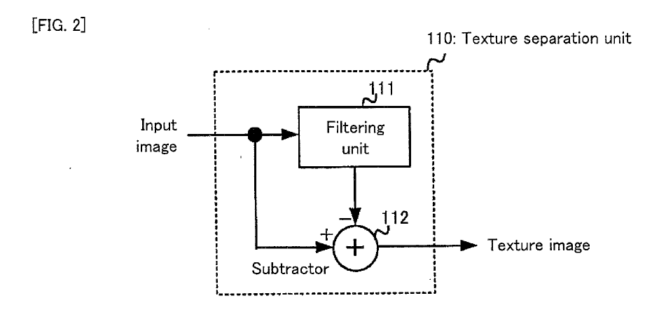

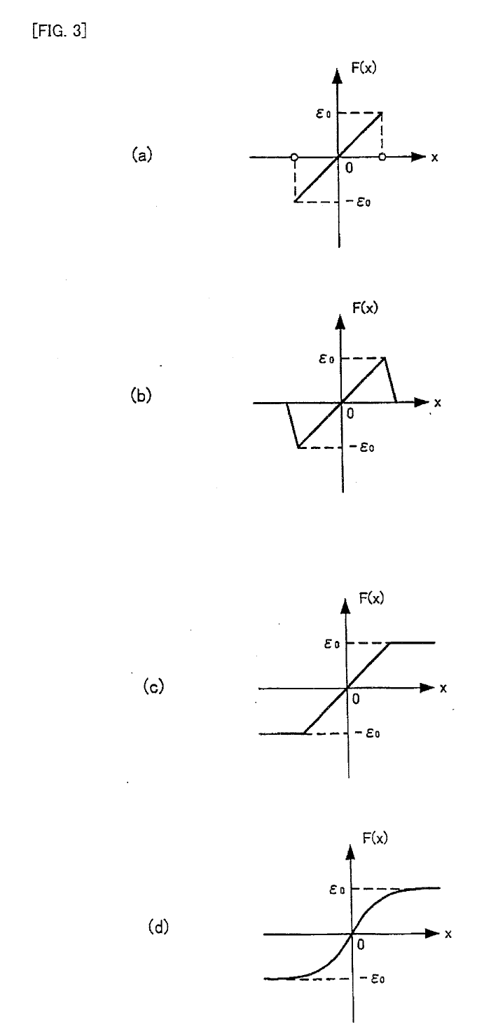

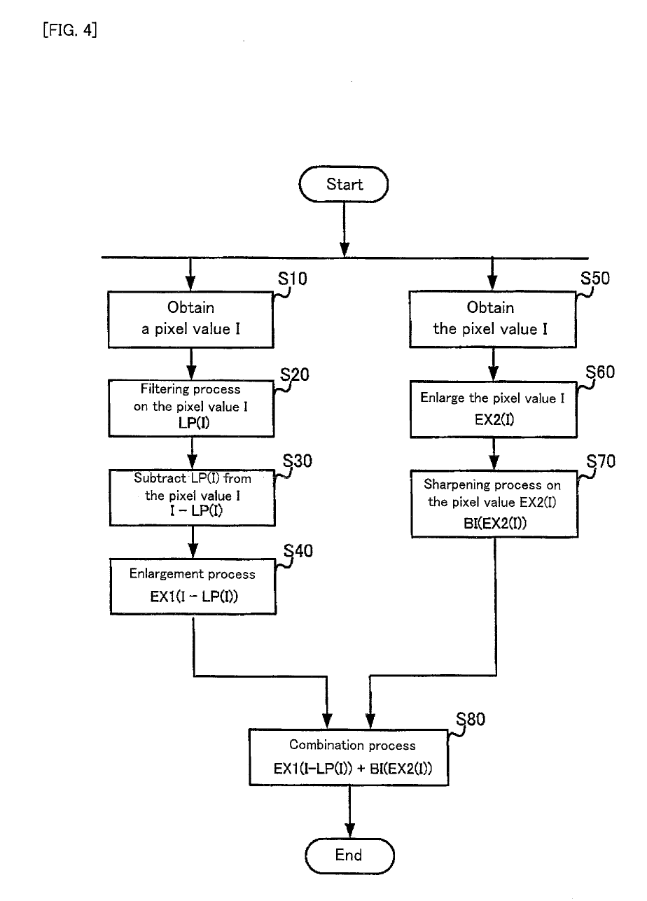

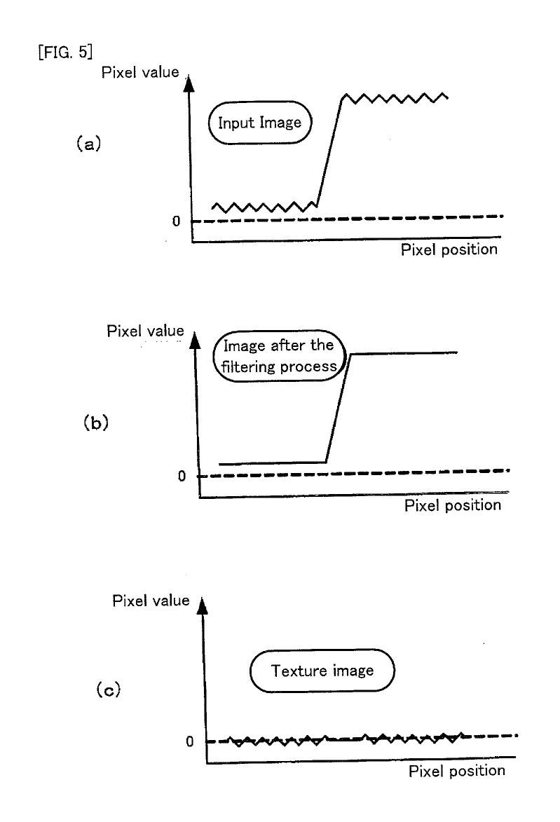

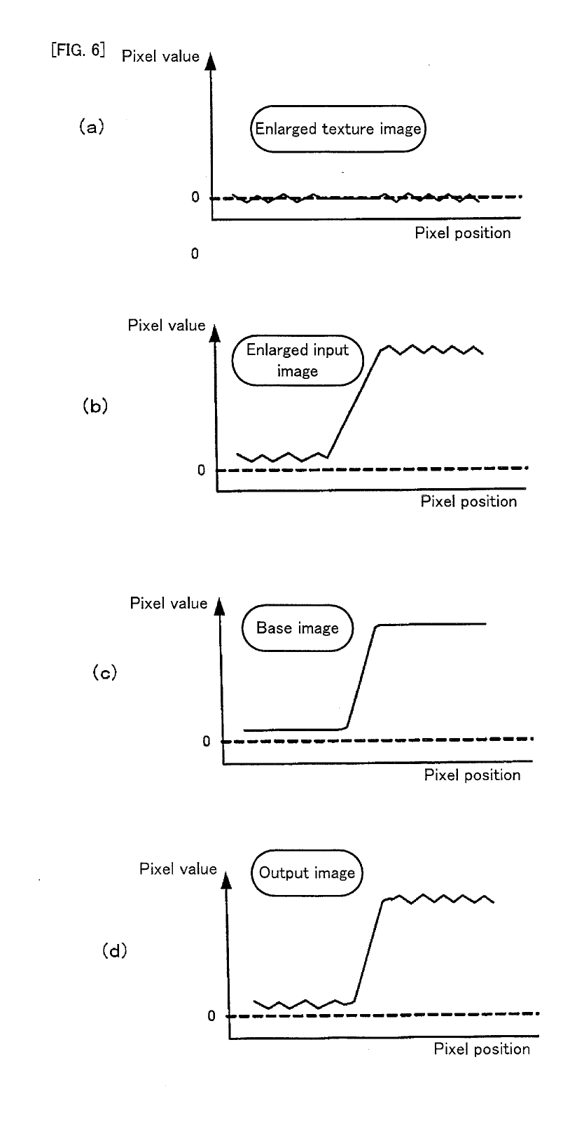

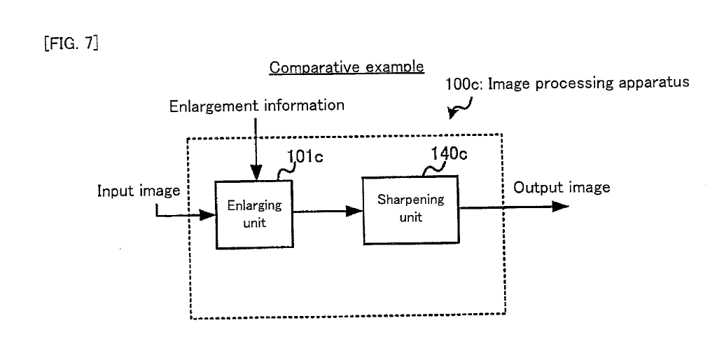

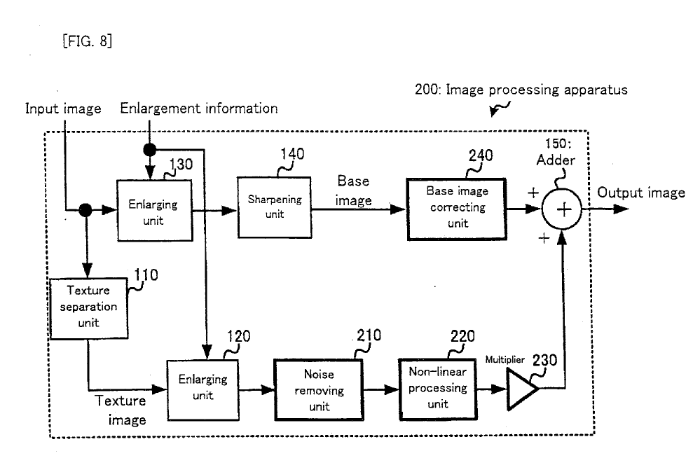

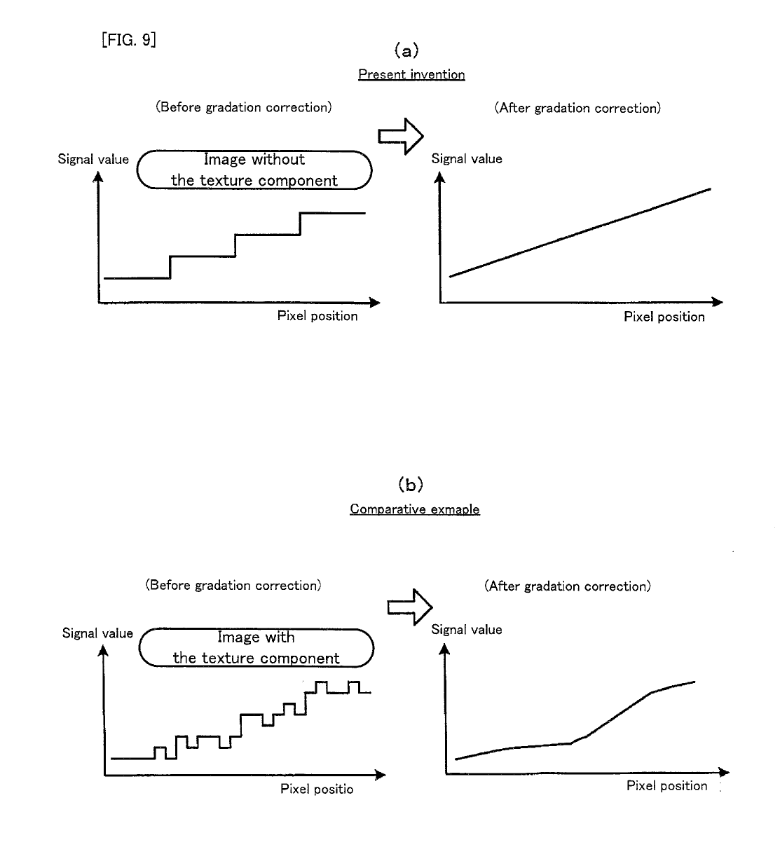

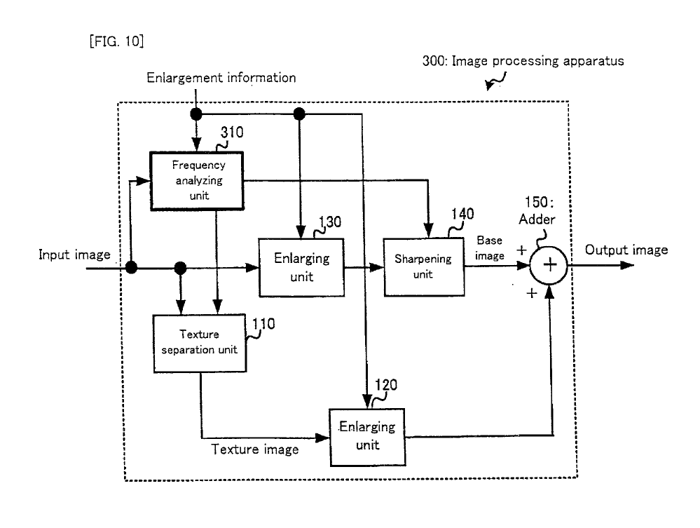

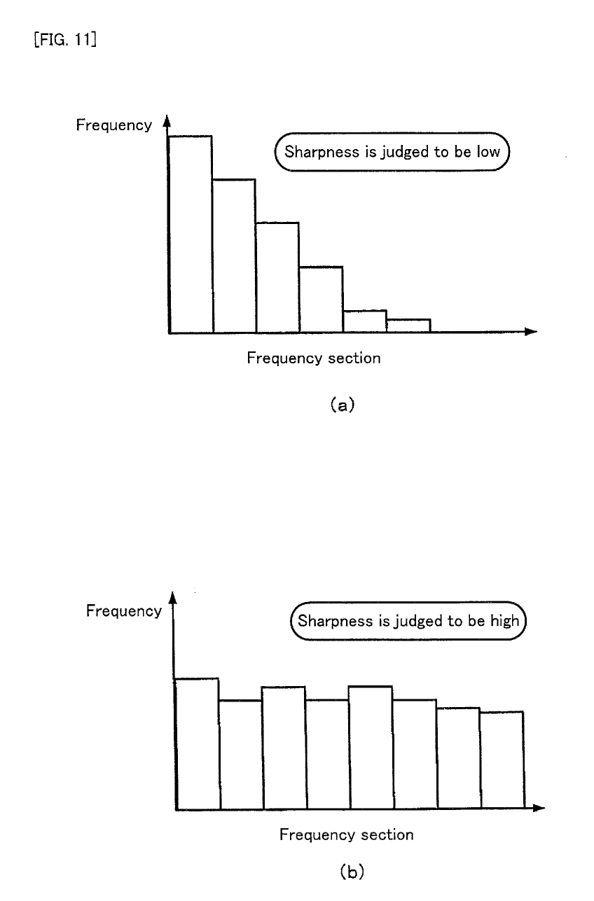

### BRIEF DESCRIPTION OF DRAWINGS

[FIG. 1] FIG. 1 is a block diagram showing the entire configuration of an image processing apparatus in a first embodiment.

[FIG. 2] FIG. 2 is a block diagram showing the detailed configuration of a texture separation unit in the first embodiment.

[FIG. 3] FIGS. 3 are graphs showing specific examples of a non-linear function in an ε filter which is one example of a filtering unit of the text separation unit in the first embodiment (FIG. 3(a) to FIG. 3(d)).

[FIG. 4] FIG. 4 is a flowchart showing a flow of operations of the image processing apparatus in the first embodiment.

[FIG. 5] FIGS. 5 are waveform diagrams showing images in which the images obtained after various processing on the texture separation unit of the image processing apparatus in the first embodiment are expressed by using a position on the image and a pixel value (FIG. 5(a) to FIG. 5(d)).

[FIG. 6] FIGS. 6 are other waveform diagrams showing images in which the images obtained after various processing on the texture separation unit of the image processing apparatus in the first embodiment are expressed by using a position on the image and a pixel value (FIG. 6(a) to FIG. 6(d)).

[FIG. 7] FIG. 7 is a block diagram showing the entire configuration of an image processing apparatus in a comparative example.

[FIG. 8] FIG. 8 is a block diagram showing the entire configuration of an image processing apparatus in a second embodiment.

[FIG. 9] FIGS. 9 are a waveform diagram showing an image that is subject to a gradation correction process in the second embodiment (FIG. 9(a)) and a waveform diagram showing an image that is subject to a gradation correction process in the comparative example (FIG. 9(b)).

[FIG. 10] FIG. 10 is a block diagram showing the entire configuration of an image processing apparatus in a third embodiment.

[FIG. 11] FIGS. 11 are graphs showing a quantitative and qualitative relation between frequency components of an input image and frequency of each frequency component (FIG. 11(a) and FIG. 11(b)).

### MODE FOR CARRYING OUT THE INVENTION

Hereinafter, the best mode for carrying out the present invention will be explained with reference to the drawings.

### First Embodiment

### (Entire Configuration)

Firstly, a first embodiment of the present invention will be explained. FIG. 1 is a block diagram showing the entire configuration of an image processing apparatus in the first embodiment.

As shown in FIG. 1, an image processing apparatus 100 in the first embodiment is provided with a texture separation unit 110, an enlarging unit 120, an enlarging unit 130, a sharpening unit 140, and an adder 150.

An input image is inputted to each of the texture separation unit 110 and the enlarging unit 130. Incidentally, the input image constitutes one example of the first image of the present invention.

The texture separation unit 110 separates a texture image from the input image and outputs it. Moreover, enlargement information is inputted to the enlarging unit 120 and the enlarging unit 130. The enlargement information may be information about a magnification for specifying how many times the input image is enlarged. Alternatively, the enlargement information may be information about the number of pixels, for specifying the number of pixels after the enlargement. Incidentally, the texture separation unit 110 constitutes one example of the obtaining device of the present invention and one example of the extracting device of the present invention.

The enlarging unit 130 performs an enlargement process on the input image to the predetermined number of pixels and outputs it to the sharpening unit 140. Incidentally, the enlarging unit 130 constitutes one example of the second enlarging device of the present invention. The enlarging unit 120 performs an enlargement process on the texture image to the predetermined number of pixels and outputs it to the adder 150. Incidentally, the enlarging unit 120 constitutes one example of the first enlarging device of the present invention.

The sharpening unit 140 performs an edge-sharpening process on the image obtained by enlarging the input image on the enlarging unit 130 and outputs a base image. Incidentally, the sharpening unit 140 constitutes one example of the base image obtaining device of the present invention.

By combining the base image and the enlarged texture image on the adder 150, an output image is obtained. Incidentally, the adder 150 constitutes one example of the combining device of the present invention.

### (Detailed Configuration of Texture Separation Unit)

Next, with reference to FIG. 2, the detailed configuration of the texture separation unit 110 in the first embodiment will be explained. FIG. 2 is a block diagram showing the detailed configuration of the text separation unit 110 in the first embodiment.

The texture separation unit 110 is provided with a filtering unit 111 and a subtractor 112. The input image is inputted to the filtering unit 111 and the subtractor 112. The filtering unit 111 performs an edge-preservation filtering process on the input image and outputs it. By subtracting the input image that is subject to the edge-preservation filtering process from the input image on the subtractor 112, the texture image is obtained. The filtering unit 111 is composed of a filter having an edge preservation effect, and it may use either an ε filter or a bilateral filter.

Go back to FIG. 1.

The enlarging unit 130 and the enlarging unit 120 can use nearest neighbor interpolation, bilinear interpolation, bicubic interpolation, and interpolation by the Lanczos-windowed sinc function filter. However, it does not mean excluding the other enlargement methods. Moreover, the enlarging unit 130 and the enlarging unit 120 may adopt the same enlargement processing method or different processing methods. However, recommended methods are the nearest neighbor method or the like in which the generation of the jaggies and the ringing is suppressed for the enlarging unit 130, and the bicubic interpolation and the interpolation by the Lanczos-windowed sinc function filter in which a high-frequency component is well enlarged for the enlarging unit 120.

The sharpening unit 140 may use either the bilateral filter having an edge-sharpening effect or a trilateral filter. The bilateral filter in the embodiment may mean a filter in which a weighting factor of the filter is determined from two elements which are (i) a spatial distance between a targeted pixel which is a target and a focused pixel and (ii) a difference between a pixel value of the targeted pixel and a pixel value of the focused pixel. The trilateral filter is a filter in which a third function is added to the bilateral filter. Typically, what can be listed as the trilateral filter is a filter in which an impulse noise detector is set as third weight, or a filter in which a function based on a gradient between the focused pixel and its surrounding pixels is added.

### (ε Filter as One Example of Filtering Unit of Texture Separation Unit)

Next, with reference to FIGS. 3, an explanation will be given on the ε filter which is one example of the filtering unit of the text separation unit. FIGS. 3 are graphs showing specific examples of a non-linear function in the ε filter which is one example of the filtering unit of the text separation unit in the first embodiment (FIG. 3(a) to FIG. 3(d)). Incidentally, in FIG. 3(a) to FIG. 3(d), a horizontal axis indicates x, which is a difference between a pixel value xn−k and a pixel value xn, and a vertical axis indicates a non-linear function F(x).

The ε filter, which is a non-linear smoothing filter, is a digital filter effective in smoothing the pixels without losing a steep change in the pixel value. The ε filter is expressed by the following equation (1) if the pixels for the filtering process are 2N+1 taps in one dimension.

$$\begin{matrix}[ Equation 1 ] & \\ {y}_{n} = {\sum }_{k = - N}^{N} {a}_{k} \{ {x}_{n} - F ( {x}_{x - n} - {x}_{n} ) \} = {\sum }_{k = - n}^{N} {a}_{k} \cdot {b}_{n - k} & ( 1 )\end{matrix}$$

Here, the function F(x) is a non-linear function in which an absolute value ((F(x))) of its function value (wherein ((a)) indicates the absolute value of a) is suppressed to ((F(x)))≦ε0. Its example is shown in FIG. 3. In the ε filter in the equation (1) described above, a difference in the pixel value between input and output is suppressed to an infinite value determined by the following equation (2).

$$\begin{matrix}[ Equation 2 ] & \\ ɛ = {ɛ}_{0} {\sum }_{k = - N}^{N} \vert {a}_{k} \vert & ( 2 )\end{matrix}$$

By this, the difference between the input and output pixel values is limited within ±ε, and the steep change in the pixel value is maintained. Here, if F(x) in FIG. 3(a) is adopted to bn−k, bn−k is expressed by the following equation (3).

$$\begin{matrix}[ Equation 3 ] & \\ {b}_{n - k} = \{ \begin{matrix}{x}_{n - k} , & \vert {x}_{n} - {x}_{n - k} \vert \leq {ɛ}_{0} \\ {x}_{n} , & \vert {x}_{n} - {x}_{n - k} \vert > {ɛ}_{0}\end{matrix} & ( 3 )\end{matrix}$$

At this time, the ε filter compares an absolute value ((xn−xn−k)), which is a difference between the pixel value xn of a center pixel of the filtering process and the pixel value xn−k of the surrounding pixel, with a predetermined threshold value ε0. As a result, if the absolute value ((xn−xn−k)) is less than the predetermined threshold value ε0, the pixel value xn−k is substituted into bn−k, and the same process as a normal low pass filter having each tap coefficient of ak is performed. By this, an image is smoothed, centered on the center pixel. On the other hand, if the absolute value ((xn−xn−k)) is greater than the predetermined threshold value ε0, the pixel value xn is substituted into bn−k, the pixel value xn−k is replaced by the pixel value xn, and then, the low pass filtering process centered on the center pixel is performed. By this, the smoothing is performed with disregard to the pixel value xn−k. Incidentally, in substantially the same manner, F(x) shown in FIG. 3(b), F(x) shown in FIG. 3(c), or F(x) shown in FIG. 3(d) may be adopted to bn−k. Moreover, regarding the detailed content about the ε filter, please refer to “Nonlinear Digital Filters and Their Applications”, Kaoru ARAKAWA, The Journal of the Institute of Electronics, Information and Communication Engineers, Vol. 77, No. 8, pp. 844-852, August 1994.

Consequently, it is possible to perform the smoothing while keeping the steep change in an edge as it is. The ε filter is configured by adapting a one-dimensional ε filter in each of the horizontal direction and the vertical direction of an image in some cases, and the ε filter is composed of a two-dimensional ε filter in some cases.

(Bilateral Filter as One Example of Sharpening unit)

Next, an explanation will be given on the bilateral filter which is one example of the sharpening unit and which is also one example of the filtering unit of the texture separation unit.

The bilateral filter is a non-linear filter and has a property of smoothing a noise without dulling the edge. The bilateral filter uses a Gaussian function as the weighting factor and weights a spatial direction and a pixel value direction (gradation direction). If it is assumed that an input pixel value at spatial coordinates (x,y) is d(x,y), that an output pixel value at the coordinates (x,y) is f(x,y), and that the number of taps is 2N+1, the bilateral filter is expressed by the following equation (4).

$$\begin{matrix}[ Equation 4 ] & \\ {f}_{x , y} = \frac{{\sum }_{k = x - N , l = y - N}^{x + N , y + N} {e}^{- α ( {( k - x )}^{2} + {( l - y )}^{2} )} \cdot {e}^{- {β ( {d}_{k , l} - {d}_{x , y} )}^{2}} \cdot {d}_{k , l}}{{\sum }_{k = x - N , l = y - N}^{x + N , y + N} {e}^{- α ( {( k - x )}^{2} + {( l - y )}^{2} )} \cdot {e}^{- {β ( {d}_{k , l} - {d}_{x , y} )}^{2}}} & ( 4 )\end{matrix}$$

Here, α, β are coefficients of the bilateral filter. If α is reduced, a smoothing range in the spatial direction is expanded, and if β is reduced, a smoothing range in the gradation direction is expanded. Regarding the detailed content about the bilateral filter, please refer to Kiichi URAHAMA, “Noise Reduction and Generation of Illustrations by Using Bilateral Filters”, The Journal of the Institute of Image Information and Television Engineers, Vol. 62, No. 8, pp. 1268-1273 (2008). Moreover, regarding a property of making a steep edge which the bilateral filter has, please refer to Kiichi URAHAMA, Kohei INOUE, “Edge-Enhancement Property of Bilateral Filters”, The Transactions of the Institute of Electronics, Information and Communication Engineers A, 2003/3 Vol. J86-A, No. 3.

### (Operation Principle)

Next, with reference to FIG. 4 to FIGS. 6, the operation principle of the image processing apparatus in the first embodiment will be explained. FIG. 4 is a flowchart showing a flow of operations of the image processing apparatus in the first embodiment.

FIGS. 5 are waveform diagrams showing images in which the images obtained after various processing on the texture separation unit of the image processing apparatus in the first embodiment are expressed by using a position on the image and a pixel value (FIG. 5(a) to FIG. 5(d)). FIGS. 6 are other waveform diagrams showing images in which the images obtained after various processing on the texture separation unit of the image processing apparatus in the first embodiment are expressed by using a position on the image and a pixel value (FIG. 6(a) to FIG. 6(d)). Incidentally, a horizontal axis in FIG. 5(a) to FIG. 5(d) and FIG. 6(a) to FIG. 6(d) indicates the position on the image (i.e. pixel position), and a vertical axis indicates the pixel value.

As shown in FIG. 4, firstly, by the texture separation unit 110, a pixel value I indicating a pixel in an image is obtained (step S10). At the same time, or before or after that, by the enlarging unit 130, the pixel value I indicating the pixel in the image is obtained (step S50). Specifically, FIG. 5(a) shows the input image. The input image is composed of: a base component (i.e. one example of the base image of the present invention) indicating a contoured portion in which the pixel value changes significantly and a flat portion in which the pixel value changes uniformly; and a texture component indicating a small change in the image (i.e. one example of the texture image of the present invention).

Following the step S10 described above, by the filtering unit 111 of the texture separation unit 110, a pixel value LP(I) which is subject to the filtering process is generated from the pixel value I (step S20). Specifically, the waveform diagram shown in FIG. 5(b) is obtained by performing the filtering process in which the level change in the pixel value is maintained in the contoured portion of the input image, i.e. in a so-called edge portion. In the image shown in FIG. 5(b), the texture component is removed while maintaining the level change in the pixel value in the edge portion.

Then, by that the subtractor 112 of the texture separation unit 110 subtracts the pixel value LP(I) from the pixel value I, a texture image “I−LP(I)” is obtained (step S30). Specifically, the texture image shown in FIG. 5(c) is obtained. This texture image is obtained by subtracting the image after the filtering process with the edge maintained, from the input image.

Then, by that the enlarging unit 120 performs the enlargement process on the texture image “I−LP(I)”, an image “EX1(I−LP(I))” is generated (step S40). Specifically, FIG. 6(a) shows the texture image obtained by enlarging the texture image shown in FIG. 5(c).

Following the obtainment of the pixel value I indicating the pixel in the image by the enlarging unit 130 (the step S50), by the enlarging unit 130, the enlargement process is performed on the obtained pixel value I and an image “EX2(I)” is obtained (step S60). Specifically, FIG. 6(b) shows the image by performing the enlargement process on the input image.

Then, by the sharpening unit 140, the sharpening process is performed, and an image “BI(EX2(I))” is generated (step S70). Specifically, FIG. 6(c) shows the base image in which by performing the sharpening process on the enlarged input image, the change in the pixel value in the edge portion is made steep and the texture component is removed from the image.

Lastly, in a step S80, the image “EX1(I−LP(I))” generated in the step S40 and the image “BI(EX2(I))” generated in the step S70 are combined by the adder 150, whereby an image “EX1(I−LP(I))+BI(EX2(I))” is generated and outputted. Specifically, FIG. 6(d) shows the output image, wherein the image “EX1(I−LP(I))+BI(EX2(I))” obtained by combining the enlarged texture image and the base image is obtained.

The bilateral filter described above is a non-linear filter and has a property of smoothing a noise without dulling the edge portion, but also has a property of making a steep edge portion. In the embodiment, this property is used to make the steep edge portion of the enlarged input image, and the sharp base image is obtained. On the other hand, if a bilateral filtering process is performed on the enlarged input image, the texture component indicating the minute change in the image is also removed. Thus, in the embodiment, the texture image is generated from the input image and the image obtained by performing the enlargement process on the texture image and the base image are combined, whereby it is possible to obtain the image with the edge portion sharpened and its details maintained.

### <First Examination on Operation and Effect in First Embodiment>

Next, with reference to FIG. 7, the operation and effect of the image processing apparatus in the first embodiment will be examined. FIG. 7 is a block diagram showing the entire configuration of an image processing apparatus in a comparative example.

As shown in FIG. 7, an image processing apparatus 100c in the comparative example is provided with an enlarging unit 101c and a sharpening unit 140c. The enlarging unit 101c performs a process of enlarging an input image to the predetermined number of pixels. The sharpening unit 140c performs a sharpening process on the enlarged input image and outputs it as an output image.

In general, by the image enlargement process, the noise component such as jaggies and ringing is at least generated. In particular, the noise component such as jaggies and ringing tends to be generated at a pixel position having a large difference in the pixel value between adjacent pixels, such as around the contour of an image, i.e. around an edge.

Thus, in the comparative example, a noise component such as jaggies and ringing generated on the enlarging unit 101c is further enhanced on the sharpening unit 140c, and this increases the degree of the noise component generated in the output image, which is technically problematic.

In contrast, on the sharpening unit 140c in the embodiment, the noise component such as jaggies and ringing generated by the enlargement process performed on the input image by the enlarging unit 130 is smoothed and reduced by the noise removal effect and the edge-sharpening effect that the bilateral filter has. Moreover, the texture image results from the subtraction of the image obtained by performing the filtering process on the input image by the filtering unit 111 from the input image. Thus, as shown in FIG. 5(c) described above, a difference in the pixel value between the pixels which constitute the texture image is extremely small. This makes it possible to remarkably suppress the generation of the noise component such as jaggies and ringing if the enlargement process is performed by the enlarging unit 120 on the texture image.

As a result, according to the embodiment, it is possible to obtain the image in which the generation of the noise component such as jaggies and ringing, which is highly likely generated in the enlargement process, is effectively suppressed.

### <Second Examination on Operation and Effect in First Embodiment>

Next, the operation and effect of the image processing apparatus in the first embodiment will be further examined.

In general, in the technology about the image enlargement based on the separation of the skeleton component and the texture component, an iterative operation process using a total variation (TV) norm in a separation process is performed. Here, the skeleton component means a component substantially similar to the base component. Moreover, even in an interpolation process for the skeleton image, transformation to a frequency band and the iterative operation process using the TV norm are performed. Thus, in the technology about the image enlargement based on the separation of the skeleton component and the texture component, the amount of image processing is enormous, and for example, in on-line type image processing using a communication line, an image processing time is long, which are technically problematic. Moreover, in the technology about the image enlargement based on the separation of the skeleton component and the texture component, in addition to the texture image, a skeleton image is also generated by the separation process. In other words, a relation in the following equation (5) holds true.

Input image=Skeleton image+Texture image+α (5)

Thus, the skeleton image is obtained by performing the separation process on the input image, and one portion of the edge portion of the skeleton image is smoothed in the separation unit. Moreover, if the smoothed skeleton image is further subject to the interpolation process, the sharpening effect in the edge portion of the skeleton image is reduced, which is technically problematic.

In contrast, according to the first embodiment, neither the process of making the transformation to the frequency band in an image signal nor the iterative operation process is performed. This makes it possible to easily realize faster image processing, to reduce the amount of the image processing, and to effectively reduce the amount of memory in the image processing. Moreover, since the sharpening process is performed after the enlargement process is performed on the input image, the edge portion is maintained without being smoothed and a better sharpening effect can be obtained.

### Second Embodiment

### (Entire Configuration)

Next, with reference to FIG. 8 and FIGS. 9, a second embodiment of the present invention will be explained. FIG. 8 is a block diagram showing the entire configuration of an image processing apparatus in the second embodiment. FIGS. 9 are a waveform diagram showing an image that is subject to a gradation correction process in the second embodiment (FIG. 9(a)) and a waveform diagram showing an image that is subject to a gradation correction process in the comparative example (FIG. 9(b)).

Incidentally, regarding constituents in the second embodiment, substantially the same constituents as those in the first embodiment described above will carry the same reference numerals, and the explanation thereof will be omitted as occasion demands. In addition, in the operations of the second embodiment, an explanation about substantially the same operations as those in the first embodiment described above will be also omitted, as occasion demands.

As shown in FIG. 8, an image processing apparatus 200 in the second embodiment is provided with a texture separation unit 110, an enlarging unit 120, a noise removing unit 210, a non-linear processing unit 220, a multiplier 230, an enlarging unit 130, a sharpening unit 140, a base image correcting unit 240, and adder 150. Incidentally, at least one of the noise removing unit 210, the non-linear processing unit 220, and the multiplier 230 constitutes one example of the correcting device for performing the first correction process of the present invention. Moreover, the base image correcting unit 240 constitutes one example of the correcting device for performing the second correction process of the present invention.

As the noise removing unit 210, a 3-dimensional noise reduction (3DNR) process and an isolated point removal process are conceivable. The 3DNR process allows the removal of a random noise or the like by performing the filtering process in a time-axis direction. The isolated point removal process is a method in which the texture component is considered to be distributed in a certain degree of size (area) and the texture component which exists in an isolated manner is judged to be a noise and is removed, thereby providing a noise reduction effect.

The non-linear processing unit 220 performs a non-linear filtering process on the texture image. For example, by performing an S-curve process, the following properties are provided: a low level of the texture component is reduced as the noise; the range of an intermediate level of the texture component considered to have a high proportion of the original texture component of the image is extended; and a certain level of the texture component is suppressed. By this, the overall image quality is improved.

The multiplier 230 controls the amount of the texture component and specifies it with a magnification of L. In the case of L=0, an image generated from the texture image is 0, and only an image generated from the base image is an output image. In the case of 0<L<1, the image generated from the texture image is reduced, is combined with the image generated from the base image, and is outputted. In the case of L=1, it is the same condition as that there is no multiplier, and the image generated from the base image and the image generated from the texture image are combined at the same ratio, resulting in the output image. In the case of L>1, the image generated from the texture image is enhanced or intensified and is combined with the image generated from the base image, resulting in the output image.

As the base image correcting unit 240, an image processing unit for performing a gradation correction process and a transient correction process is conceivable. In the gradation correction process, when an area with a gentle gradation change (gradation area) is distinguished, a uniform gradation change in the gradation area is realized by performing a low-pass filtering process or linear interpolation in the area. The transient correction process is image processing in which the inclination of the edge is increased by a spatial process and which is performed on at least one of a luminance signal and a color signal.

In the second embodiment, the base image outputted with the edge sharpened by the sharpening unit 140 is inputted to the adder 150 through the base image correcting unit 240. In addition, the texture image enlarged and outputted by the enlarging unit 120 is inputted to the adder 150 through the noise removing unit 210, the non-linear processing unit 220, and the multiplier 230. On the adder 140, the inputted base image and the inputted texture image are combined and outputted as the output image.

In particular, in the second embodiment, the base image after the sharpening process by the sharpening unit 140 is smoothed with the edge maintained. The base image is composed of an edge portion and a flat portion, and the texture component is significantly reduced. By this, on the base image correcting unit 240 in the second embodiment, the gradation correction process is performed on the base image in which the texture component is reduced. Thus, the gradation correction process can be well performed. Specifically, as shown in FIG. 9(a), in the gradation correction process in the second embodiment, the pixel value can be linearly changed depending on a gradual change in the pixel value in the base image in which the texture component is reduced, and the gradation correction process can be well performed.

If the gradation correction process is performed on the image having a high proportion of the texture component, as shown in FIG. 9(b), there is a possibility that the texture component is an obstacle and that the gradation correction process cannot be properly performed, which is technically problematic.

In addition, on the base image correcting unit 240 in the second embodiment, the transient correction process is performed on the base image in which the texture component is reduced. Thus, the transient correction process can be well performed. Specifically, in the base image in which the texture component is reduced, the inclination of the change in the pixel value of the contour can be made steep depending on a gradual change in the pixel value near the contour without influencing the texture component, and thus, the transient correction process can be well performed.

If the transient correction process is performed on the image having a high proportion of the texture component, there is a possibility that the texture component is an obstacle and that the transient correction process cannot be properly performed, which is technically problematic.

Moreover, in general, the random noise included in the image is a component including a small change in the pixel value of the image, and thus it is classified as a component similar to the texture component. In particular, if the 3-dimensional noise reduction which is a filtering process in the time-axis direction, i.e. the so-called 3DNR process, is performed on the input image, a so-called afterimage becomes problematic. Moreover, particularly, the afterimage tends to be generally detected in the contour of the image, i.e. in the edge portion.

In contrast, the noise removing unit 210 in the second embodiment performs the 3DNR process only on the texture image not including the contour of the image, i.e. the edge portion. By this, the 3DNR process on the noise removing part 210 does not influence the edge portion of the image. By this, according to the second embodiment, it is possible to effectively reduce the generation of the afterimage while removing the random noise in the 3DNR process, and thus, it is extremely useful in practice.

In addition, the noise component generally removed in the isolated point removal process is also a component including a small change in the pixel value of the image, and thus, it is classified as a component similar to the texture component.

On the noise removing unit 210 in the second embodiment, the isolated point removal process is performed only on the texture image. By this, the noise removing unit 210 performs the isolated point removal process with little or no influence of an image portion in which the pixel value significantly changes, such as the contour of the image, i.e. the edge portion. Thus, it is possible to increase the accuracy of detecting the noise, such as an isolated point, and to effectively perform the noise removal, which is extremely useful in practice.

Moreover, according to the second embodiment, the non-linear process and the multiplier process described above are performed on the texture image but not on the base image. This makes it possible to maintain the level of the pixel value in the edge portion and the flat portion in the base image. Thus, it is possible to improve the granularity and details of the image and to increase the contrast of the image, which is extremely preferable in practice.

### Third Embodiment

### (Entire Configuration)

Next, with reference to FIG. 10 and FIGS. 11, a third embodiment of the present invention will be explained. FIG. 10 is a block diagram showing the entire configuration of an image processing apparatus in the third embodiment. FIGS. 11 are graphs showing a quantitative and qualitative relation between frequency components of an input image and frequency of each frequency component (FIG. 11(a) and FIG. 11(b)).

Incidentally, regarding constituents in the third embodiment, substantially the same constituents as those in the first embodiment described above will carry the same reference numerals, and the explanation thereof will be omitted as occasion demands. In addition, in the operations of the third embodiment, an explanation about substantially the same operations as those in the first embodiment described above will be also omitted, as occasion demands.

As shown in FIG. 10, an image processing apparatus 300 in the third embodiment is provided with a texture separation part 110, an enlarging unit 120, an enlarging unit 130, a sharpening unit 140, an adder 150, and a frequency analyzing unit 310. Incidentally, the frequency analyzing unit 310 constitutes one example of the measuring device of the present invention.

The frequency analyzing unit 310 analyzes a spatial frequency component of an input image and sets at least one of the number of taps and a filter coefficient on the sharpening unit on the basis of a result of the analysis and enlargement information. The frequency analyzing unit 310 also analyzes the spatial frequency component of the input image and sets at least one of the number of taps and the filter coefficient on the texture separation unit on the basis of the analysis result and the enlargement information. The input image is inputted to each of the texture separation unit 110, the enlarging unit 120, and the frequency analyzing unit 310. The enlargement information is inputted to each of the texture separation unit 110, the enlarging unit 120, and the frequency analyzing unit 310. Information about the result of the frequency analysis by the frequency analyzing unit 310 is inputted to each of the texture separation unit 110 and the sharpening unit 140.

As a method of analyzing the spatial frequency component, any process of Wavelet transform, Fourier transform, Discrete Cosine Transform (DCT) and Hadamard transform is performed to obtain a frequency distribution statistic. From the statistic, the sharpness of the image is judged, and at least one of the number of taps and the filter coefficient is set. As the filter coefficient set for the filtering unit of the texture separation unit from the frequency analyzing unit, in the case of the ε filter, an ε value and the selection of a non-linear function can be listed. In the case of the bilateral filter, as the filter coefficient, a coefficient α and a coefficient β can be listed. As parameter setting from the frequency analyzing unit to the sharpening unit, there are the coefficient α and the coefficient β. Here, the ε value means ε0 in the equation (3) described above. Moreover, the selection of the non-linear function means the selection of one of the non-linear functions in FIG. 3(a) to FIG. 3(d). Moreover, the coefficient α means α in the equation (4) described above. Moreover, the coefficient β means β in the equation (4) described above.

As one example, the input image is Fourier-transformed and expanded into a frequency area. The image data expanded into the frequency area is subject to histogram processing to obtain the frequency distribution statistic. On the basis of this statistic, as shown in FIG. 11(b), for example, if a high-frequency component exists at substantially the same frequency as that of a low-frequency component and if the degree of the high-frequency component included is high, then, it may be judged that that the sharpness is high. On the other hand, as shown in FIG. 11(a), for example, if the frequency of the high-frequency component decreases as a frequency section increases in comparison with the frequency of the low-frequency component, if eventually the frequency of the high-frequency component disappears, and if the degree of the high-frequency component included is low, then, it may be judged that that the sharpness is low.

Typically, if the sharpness is high, the number of taps may be changed in an increase direction, and if the sharpness is low, the number of taps may be changed in a reduction direction. In order to avoid a rapid change, it may be considered to have a transition section in which the change in the number of taps is zero independently of the degree of the sharpness. Moreover, the aforementioned process may be performed on one image but may be performed only on a certain block area of the one image. Moreover, considering that the frequency distribution varies depending on a pattern or design, the frequency distribution statistic may be obtained from an accumulated value or an average value of a plurality of images. As the frequency analysis process, a method of performing a reset process by scene changing or channel changing is also conceivable. Moreover, as one example in which the enlargement information is used, after the number of taps is obtained from the analysis of the spatial frequency component, the number of taps is increased in view of the enlargement information. For example, if the enlargement information is specified to enlarge both the number of horizontal pixels and the number of vertical pixels by a multiplication of n, the number of taps specified may be determined by the following equation (6).

The number of taps specified=(the number of taps in the analysis result)×n (6)

wherein, n is a magnification.

As a result, according to the third embodiment, by judging the sharpness of the input image in advance by using the frequency analyzing unit 310, it is possible to maintain the degree of the granularity and details of the image described above at a certain level with respect to various input images, which is extremely preferable in practice.

The present invention is not limited to the aforementioned embodiments, but various changes may be made, if desired, without departing from the essence or spirit of the invention which can be read from the claims and the entire specification. An image processing apparatus, an image processing method, an image processing program, and a storage medium, all of which involve such changes, are also intended to be within the technical scope of the present invention.

### INDUSTRIAL APPLICABILITY

The present invention can be applied, for example, to an image processing apparatus, such as a digital camera, a display apparatus like a liquid crystal TV, a PDP, an organic EL, etc., an image reproducing apparatus like a DVD, a Blu-ray, a HD-DVD, a HDD recorder, a personal computer, etc., and a digital broadcast receiving apparatus like a terrestrial digital broadcast receiving terminal, a cable digital broadcast receiving terminal, a satellite digital broadcast receiving terminal, an IP broadcast receiving terminal, a car navigation, a mobile phone, a one-segment receiving device, etc. The present invention can be also applied to an image processing method on the image processing apparatus. In addition, the p present invention can be also applied to an image processing method such as still image and motion picture editing software and still image and motion picture playback software, an image processing program, and a storage medium on which the image processing program is stored.

### DESCRIPTION OF REFERENCE CODES

100 image processing apparatus
110 texture separation unit
111 filtering unit
112 subtractor
120 enlarging unit
130 enlarging unit
140 sharpening unit
150 adder
200 image processing apparatus
210 noise removing unit
220 non-linear processing unit
230 multiplier
240 base image correcting unit
300 image processing apparatus
310 frequency analyzing unit

1-13. (canceled)

14. An image processing apparatus comprising:
an obtaining device for obtaining a first image;
an extracting device for extracting a texture component included in the obtained first image as a texture image from the obtained first image;
a first enlarging device for enlarging the extracted texture image;
a second enlarging device for enlarging the obtained first image;
a base image obtaining device for obtaining a base image in which a contour sharpening process and a texture component reduction process or removal process are performed on the enlarged first image to sharpen only a contour; and
a combining device for combining the enlarged texture image and the obtained base image.

15. The image processing apparatus according to claim 14, wherein said base image obtaining device obtains the base image by using a bilateral filter or a trilateral filter.

16. The image processing apparatus according to claim 14, wherein said extracting device extracts the texture image by subtracting, from the obtained first image, an image obtained by performing bilateral filtering or ε filtering on the obtained first image.

17. The image processing apparatus according to claim 14, further comprising a correcting device for performing at least one of a first correction process and a second correction process, the first correction process performing on the enlarged texture image a correction according to a property of the enlarged texture image, the second correction process performing on the obtained base image a correction according to a property of the obtained base image,
said combining device combining the texture image and the base image after the at least one of the correction processes is performed.

18. The image processing apparatus according to claim 17, wherein said correcting deice performs at least one correction of a 3-dimensional noise reduction process, an isolated point removal process, a non-linear process, and a multiplication process on the enlarged texture image as the first correction process, thereby correcting the enlarged texture image.

19. The image processing apparatus according to claim 17, wherein said correcting deice performs at least one process of a gradation correction process and a transient correction process on the obtained base image as the second correction process, thereby correcting the obtained base image.

20. The image processing apparatus according to claim 14, further comprising a measuring device for measuring a distribution of frequency components in an arbitrary area of the obtained one first image or each first image of a group of a plurality of first images, wherein
in addition to or instead of that said base image obtaining device obtains the base image on the basis of the measured distribution of frequency components,
said extracting device extracts the texture image on the basis of the measured distribution of frequency components.

21. The image processing apparatus according to claim 20, wherein
in addition to or instead of that said base image obtaining device obtains the base image by changing at least one of the number of taps and a filter coefficient in accordance with the measured distribution of frequency components,
said extracting device extracts the texture image by changing at least one of the number of taps and the filter coefficient in accordance with the measured distribution of frequency components.

22. The image processing apparatus according to claim 20, wherein said measuring device initializes the measurement of the frequency components in each scene or each channel in obtaining the first image.

23. The image processing apparatus according to claim 20, wherein said base image obtaining device obtains the base image on the basis of enlargement information for enlarging the first image in addition to the measured distribution.

24. An image processing method comprising:
an obtaining process of obtaining a first image;
an extracting process of extracting a texture component included in the obtained first image as a texture image from the obtained first image;
a first enlarging process of enlarging the extracted texture image;
a second enlarging process of enlarging the obtained first image;
a base image obtaining process of obtaining a base image in which a contour sharpening process and a texture component reduction process or removal process are performed on the enlarged first image to sharpen only a contour; and
a combining process of combining the enlarged texture image and the obtained base image.

25. An non-transitory storage medium for storing therein an image processing program executed by an apparatus comprising a computer, said image processing program making the computer function as:
an obtaining device for obtaining a first image;
an extracting device for extracting a texture component included in the obtained first image as a texture image from the obtained first image;
a first enlarging device for enlarging the extracted texture image;
a second enlarging device for enlarging the obtained first image;
a base image obtaining device for obtaining a base image in which a contour sharpening process and a texture component reduction process or removal process are performed on the enlarged first image to sharpen the contour; and
a combining device for combining the enlarged texture image and the obtained base image.
